(19) United States
(12) Patent Application Publication
(10) Pub. No.: US 2021/0089226 A1
(43) Pub. Date: Mar. 25, 2021

(54) ADAPTIVE WEAR LEVELING FOR DRIVE ARRAYS

(71) Applicant: International Business Machines Corporation, Armonk, NY (US)

(72) Inventors: Janani Swaminathan, Porur (IN); Trinadhachari Kosuru, Bangalore (IN); Sharath Manjunath, Mysore (IN); Anil Bindu Lingambudi, Bangalore (IN)

(21) Appl. No.: 16/577,071

(22) Filed: Sep. 20, 2019

(51) Int. Cl. G06F 3/06; G06F 12/0802

(52) U.S. Cl. CPC G06F 3/0649; G06F 3/0653; G06F 12/0802; G06F 2212/7211; G06F 3/0679; G06F 3/0607; G06F 3/0619

(57) ABSTRACT

Aspects of the present invention disclose a method, computer program product, and system for implementing wear leveling across a drive array. The method includes one or more processors identifying a set of storage devices in a storage system. Each storage device of the set of storage devices assigned to a corresponding endurance tier based on historical utilization. The endurance tiers correspond to a range of device endurance remaining for a storage device. The method further includes one or more processors monitoring real-time endurance factor information for the set of storage devices. In response to determining that the monitored real-time endurance factor information indicates that the set of storage devices are not wearing evenly, the method further includes one or more processors reassigning at least one storage device of the set of storage devices to an updated endurance tier, corresponding to utilization of the at least one storage device.

### BACKGROUND OF THE INVENTION

The present invention relates generally to the field of data storage, and more particularly to managing wear across a drive array.

Computer data storage (e.g., memory, hard disk drives (HDDs), solid-state drives (SSDs), etc.) is a technology that includes computer components and recording media that are used to retain digital data. A disk array or drive array is a hardware element of a computing system that includes a group of data storage devices, such as HDDs and/or SSDs. A disk or drive array can include several trays (or drawers) of storage devices, and a corresponding architecture to support increases access speed and security. A storage area network (SAN) can include one or more disk arrays that function as a repository for data that is moved in and out of the SAN.

The data within a disk or drive array can be organized into Logical Units (LUs). A Logical Unit Number (LUN) is a unique identifier that is used to distinguish between devices that share a common bus in a disk or drive array. Commands that are sent to a storage controller identify devices based on their LUNs.

Write endurance is the number of program/erase (P/E) cycles that can be applied to a block of flash memory before the storage media becomes unreliable. Write endurance is calculated by estimating how often and how thoroughly the flash media is used. Some manufacturers provide an estimate of longevity based on an arbitrary amount of data written/erased per day, but many vendors simply provide a mean-time-to-failure (MTTF) estimate.

### SUMMARY

Aspects of the present invention disclose a method, computer program product, and system for implementing wear leveling across a drive array. The method includes one or more processors identifying a set of storage devices in a storage system. Each storage device of the set of storage devices is assigned to a corresponding endurance tier based on historical utilization of respective storage devices. The endurance tiers correspond to a range of device endurance remaining for a storage device. The method further includes one or more processors monitoring real-time endurance factor information for the set of storage devices. In response to determining that the monitored real-time endurance factor information indicates that the set of storage devices are not wearing evenly, the method further includes one or more processors reassigning at least one storage device of the set of storage devices to an updated endurance tier, corresponding to utilization of the at least one storage device. In an additional aspect of the present invention, the method further includes one or more processors reallocating data stored in the set of storage devices based on the reassignment of the at least one storage device of the set of storage devices to the updated endurance tier.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for assigning storage devices to respective endurance tiers, in accordance with an embodiment of the present invention.

FIG. 3 is a flowchart depicting operational steps of a program for dynamically managing a drive array based on drive endurance information, in accordance with an embodiment of the present invention.

FIG. 4 depicts a block diagram of components of a computing system representative of the computer system, drive array, and corresponding architecture of FIG. 1, in accordance with an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

Embodiments of the present invention allow for implementing wear leveling across a drive array, such as solid-state drives (SSDs) in a drawer. In additional aspects of the present invention, embodiments provide a wear leveling mechanism, performed at the adapter level, to an array of a plurality of heterogenous storage devices. Various embodiments of the present invention utilize communication with respective controllers of storage devices to monitor real-time endurance information, to ensure uniform wear for drives in an array. Accordingly, embodiments of the present invention facilitate a process to evenly wear drives across a defined region, such as a logical unit number (LUN) of a disk array. Embodiments of the present invention utilize real-time workload behavior of an application and drive types to provide leveling of wear across drives in a storage system.

Some embodiments of the present invention recognize that in an array of storage devices, the storage devices can each have different endurance information (e.g., drive life remaining). For example, an application is assigned a storage space that spans across multiple storage drives in a drive array. The application is agnostic to the physical drive being accessed, or whether the application is utilizing the drive extensively or sparingly. Accordingly, the drives in the storage space of the application will not wear evenly. Embodiments of the present invention recognize that traditional processes and applications can manage wear leveling within a drive of a storage system utilizing an application-specific integrated circuit (ASIC) controlled located on a drive (e.g., integrated to a printed circuit board (PCB)).

Further, embodiments of the present invention provide a method of wear leveling at the drive level, which facilitates wear leveling in a heterogeneous drive array. For example, embodiments of the present invention are aware of the properties (e.g., endurance information) of dissimilar SSDs in a heterogeneous SSD array, which provides wear leveling across the heterogeneous SSD array. Accordingly, embodiments of the present invention can improve system performance in cold data storage, as well as for read-intensive tasks, through implementing wear leveling across the drives in the data storage system (e.g., the heterogeneous SSD array).

Implementation of embodiments of the invention may take a variety of forms, and exemplary implementation details are discussed subsequently with reference to the Figures.

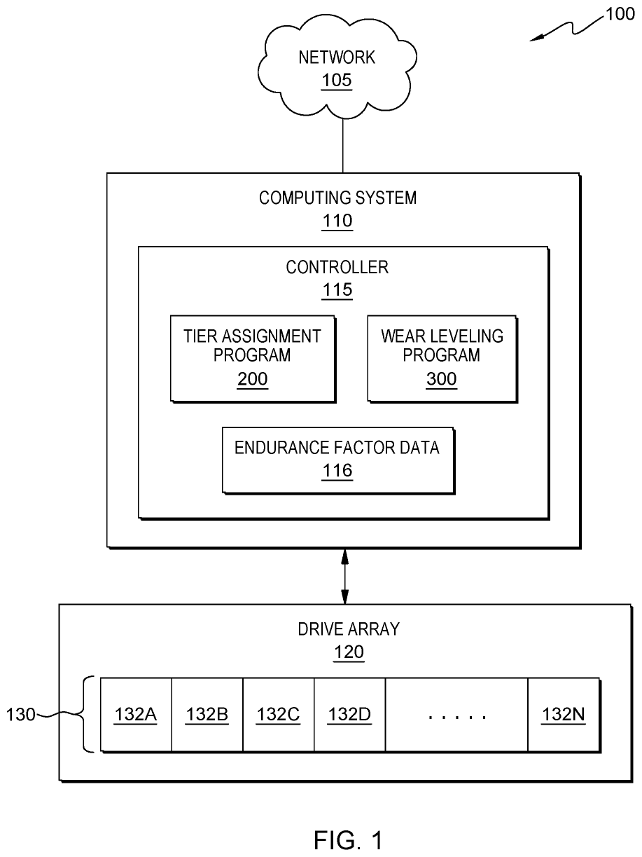

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes computing system 110, communicatively connected to drive array 120. In the depicted embodiment, computing system is connected to network 105, which facilitated communication with external computing systems (not shown) to computing system 110 and drive array 120. In an example embodiment, computing system 110 is representative of a host computing system, that is in communication with drive array 120. In another example embodiment, computing system 110 is representative of a host device corresponding to a storage system that include drive array 120 (e.g., a component of a storage system, computing system 110 in communication with drive array 120 via bus architecture, etc.).

For example, external applications (not shown) access and utilize computing system 110 and drive array 120. External applications can be assigned a storage space that spans multiple drives (e.g., storage devices, memory, SSDs, non-volatile memory, etc.) within drive array 120. In this example, computing system 110 controls the assignment and utilization of storage space within the storage devices located within drive array 120, in accordance with embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between computing system 110, drive array 120, and external computing systems and associated applications (not shown), in accordance with embodiments of the present invention. In various embodiments, network 105 facilitates communication among a plurality of networked computing devices (e.g., computing system 110, drive array 120, and external computing systems and associated applications), corresponding users, and corresponding management services.

In various embodiments of the present invention, computing system 110 may be a workstation, personal computer, personal digital assistant, mobile phone, or any other device capable of executing computer readable program instructions, in accordance with embodiments of the present invention. In an additional embodiment of the present invention, computing system 110 can be a desktop computer, a computer server, or any other computer systems, known in the art. In certain embodiments, computing system 110 represents computer systems utilizing clustered computers and components (e.g., database server computers, application server computers, etc.) that act as a single pool of seamless resources when accessed by elements of data processing environment 100, and or external computing devices and applications (not shown).

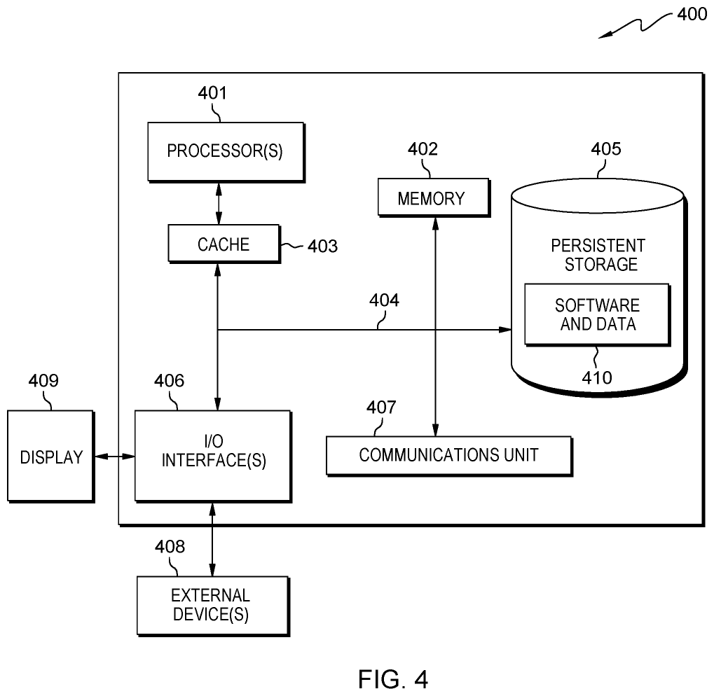

In general, computing system 110 is representative of any electronic device or combination of electronic devices capable of executing computer readable program instructions. Computing system 110 may include components as depicted and described in further detail with respect to FIG. 4, in accordance with embodiments of the present invention. In an example embodiment, computing system 110 is representative of a host computing system, that is in communication with drive array 120, and facilitates use of storage devices located in drive array 120.

Computing system 110 includes controller 115. Controller 115 includes endurance factor data 116, tier management program 200, and wear leveling program 300. In various embodiments of the present invention, controller 115 operates to manage usage of storage devices within drive array 120, to implement wear leveling of the storage devices in drive array 120. In example embodiments, controller 115 can be implemented in hardware or software, within computing system 110.

Endurance factor data 116 includes information associated with endurance factors and endurance tiers of storage devices in drive array 120. Endurance factor data 116 can be implemented with any type of storage device, for example, persistent storage 405, which is capable of storing data that may be accessed and utilized by computing system 110, such as a database server, a hard disk drive, or a flash memory. In other embodiments, endurance factor data 116 can represent multiple storage devices and collections of data within computing system 110.

For example, as external applications utilize storage space in drive array (e.g., read/write operations, etc.), the storage devices experience wear. Due to the external application being agnostic to the physical drive being accessed and utilized, or whether the application is utilizing the drive extensively or sparingly, the drives of drive array 120 that correspond to the storage space of the application will not wear evenly.

In various embodiments of the present invention, controller 115 can track and monitor wear on the storage devices of drive array 120 through storing endurance information for respective storage devices in endurance factor data 116. Accordingly, controller 115 can utilize endurance factor data 116 to track an endurance type/tier and amount of life left for storage devices/drives in drive array 120. In example embodiments, controller can track endurance factors for storage devices (in endurance factor data 116) corresponding to rated and used program/erase (P/E) cycles for a drive, amount of retired blocks of a drive, reserve block count of a drive, or other parameters that are relevant to endurance for a drive.

In additional embodiments of the present invention, controller 115 utilizes endurance factor data 116 to track and monitor endurance tiers that are associated with (i.e., assigned to) respective storage devices in drive array 120. In example embodiments, controller 115 (via tier management program 200 and wear leveling program 300) utilizes endurance factor data (e.g., rated and used P/E cycles, etc.) for drives in drive array 120 to dynamically assign the drives to an endurance tier.

Endurance tiers correspond to levels of remaining endurance (i.e., remining drive life) for storage devices. In example embodiments, controller 115 assigns storage devices to one of: Tier A, Tier B, or Tier C. In alternate embodiments, controller 115 can utilize more or less endurance tiers, in accordance with embodiments of the present invention. In an example scenario, controller 115 defines the endurance tiers based on a percentage of calculated remaining endurance for a respective drive (based on data in endurance factor data 116). In this example scenario, Tier A is reserved for drives with greater than or equal to 80% endurance, Tier B is reserved for drives with between 50% and 80% endurance, and Tier C is reserved for drives with less than or equal to 50% endurance. In alternate scenarios, controller 115 can utilize different values for assigning endurance tiers (e.g., based on administrator preferences, enterprise policy, application requirements, etc.).

In example embodiments, tier management program 200 assigns storage devices to respective endurance tiers, in accordance with embodiments of the present invention. Controller 115 can utilize tier management program 200 to assign storage devices of device array 120 to corresponding endurance tiers (e.g., based on data in endurance factor data 116). Tier management program 200 stores endurance tier assignments for storage devices of drive array 120 in endurance factor data 116.

In example embodiments, wear leveling program 300 dynamically manages a drive array based on drive endurance information, in accordance with embodiments of the present invention. In various embodiments, wear leveling program 300 monitors endurance factors of each storage device in drive array 120 (or a subset of drive array 120, such as a defined LUN). In response to determining that the wear across the storages devices is not even, wear leveling program 300 reassigns the storage devices to updated endurance tiers and reallocates data stored in the storage devices accordingly.

In various embodiments of the present invention, drive array 120 is representative of a data storage component that includes an organized collection of a plurality of hardware storage devices (e.g., SSDs or other non-volatile memory). Computing system 110 operates in combination with drive array 120 to provide a data storage virtualization technology that combines multiple physical disk drive components into one or more logical units for the purposes of data redundancy, performance improvement, or both. In example embodiments, drive array 120 includes a plurality of groups of storage devices (e.g., storage drawers), such as storage drawer 130. In the depicted embodiment of FIG. 1, drive array includes an instance of a storage drawer (i.e., storage drawer 130); however, in additional embodiments drive array 120 includes additional instances of storage drawers (not shown).

Storage drawer 130 includes drive 132A, drive 132B, drive 132C, drive 132D, through drive 132N. In various embodiments, storage drawer 130 can include any number of drives, in accordance with embodiments of the present invention. In example embodiments, drive 132A through drive 132N can be representative of any applicable data storage device, in accordance with embodiments of the present invention. In an example, drive 132A through drive 132N of storage drawer 130 are SSDs. In another example, drive 132A through drive 132N of storage drawer 130 are representative of a heterogeneous array of SSDs in drive array 120. A heterogeneous drive array includes differing storage devices (e.g., dissimilar SSDs, with different respective endurance information and life remaining) arranged in the same group (e.g., storage drawer, LUN, etc.). In one embodiment, storage drawer 130 includes storage devices (i.e., drive 132A through drive 132N) that are assigned to a common LUN. In another embodiment, storage drawer 130 includes storage devices that are assigned to multiple LUNs (e.g., a subset of drive 132A through drive 132N correspond to a LUN, etc.).

In various embodiments of the present invention, each instance of drive 132A through drive 132N includes a drive controller (e.g., operating in firmware) that provides operational information to controller 115, which include endurance factor information for the respective drives. For example, as data is written to drive 132B, the drive controller of drive 132B monitors the activity and sends the collected information to controller 115. In this example, controller 115 updates endurance factor data 116 with the information from the drive controller of drive 132B.

In example embodiments, each instance of drive 132A through drive 132N is assigned to an endurance tier, such as Tier A, Tier B, or Tier C (as previously discussed). In various embodiments of the present invention, controller 115 (via tier assignment program 200 and wear leveling program 300) dynamically assigns, and reassigns, drive 132A through drive 132N to a corresponding endurance tier, based on real-time drive endurance. Controller 115 stores the endurance tier association in endurance factor data 116.

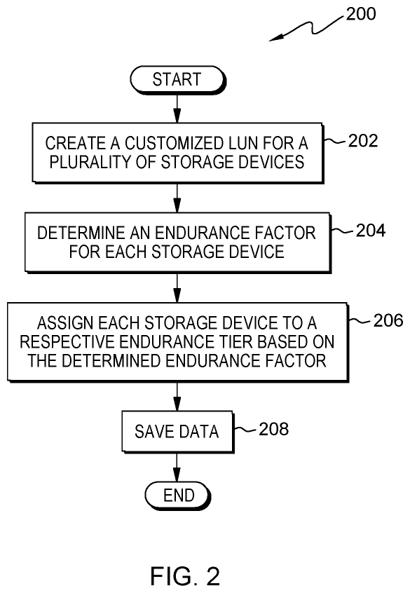

FIG. 2 is a flowchart depicting operational steps of tier assignment program 200, a program for assigning storage devices to respective endurance tiers, in accordance with an embodiment of the present invention. In one embodiment, tier assignment program 200 initiates in response to a user request (e.g., system administrator) to assign storage devices of a system to endurance tiers. In another embodiment, tier assignment program 200 initiates periodically (i.e., at defined intervals). In an example embodiment, tier assignment program 200 initiates as a configuration process during a set-up phase of an array of storage devices, such as drive array 120. For example, tier assignment program 200 can initiate in response to an addition and/or removal of a drive included in drive array 120 (e.g., a new drive replacing a failed drive, etc.).

In step 202, tier assignment program 200 creates a customized LUN for a plurality of storage devices. In one embodiment, tier assignment program 200 identifies a plurality of storage devices, from drive array 120, for inclusion in a LUN (e.g., based on definition from a user or administrator, based on application specifications, etc.). In an example scenario, drive array 120 is a heterogeneous array of storage devices, including storage drawer 130, which includes a heterogeneous grouping of SSDs, i.e., drive 132A through drive 132N. In this example, tier assignment program 200 creates a LUN that includes drive 132A, drive 132B, drive 132C, and drive 132D.

In other examples, tier assignment program 200 can create one or more LUNs to include any combination of a set of, or all, drives of drive array 120, in accordance with embodiments of the present invention. In an embodiment, tier assignment program 200 creates the customized LUN to present the heterogeneous array of SSDs to an external application as one representative LUN. In additional embodiments, can identify drives for inclusion in a LUN based on drive characteristics. For example, tier assignment program 200 can determine that a drive of drive array 120 fails and is replaced by a new drive. Tier assignment program 200 can identify the new drive for inclusion in a LUN (e.g., associated with the failed drive, another LUN, etc.).

In step 204, tier assignment program 200 determines an endurance factor for each storage device. In one embodiment, tier assignment program 200 determines a respective endurance factor value for each storage device of the plurality of storage devices included in the customized LUN. In an example embodiment, tier assignment program 200 identifies endurance information, from endurance factor data 116, for drive 132A, drive 132B, drive 132C, and drive 132D. For example, tier assignment program 200 accesses endurance factor data and identifies information for the storage devices including: rated and used program/erase (P/E) cycles for a drive, amount of retired blocks of a drive, reserve block count of a drive, number of available blocks, or other parameters that are relevant to endurance for a drive. Accordingly, tier assignment program 200 can utilize the identified information to calculate an endurance factor value for each storage device of the plurality of storage devices included in the customized LUN.

In various embodiments of the present invention, tier assignment program 200 determines an endurance factor for a storage devices to represent an estimates amount of drive life remaining, based on gathered information in endurance factor data 116. In an example scenario, tier assignment program 200 identifies that endurance factor data 116 indicates that drive 132A has used 22% of rated P/E cycles, based on the rated P/E cycle of drive 132A in relation to the amount of P/E cycles already exhausted. In this scenario, tier assignment program 200 determines an endurance factor of 78% for drive 132A. In additional scenarios, tier assignment program 200 can incorporate an amount of available and/or retired blocks of drive 132A into the determination of the endurance factor value (e.g., averaging in a percentage of available blocks). In additional embodiments, tier assignment program 200 can determine respective endurance factor values for storage devices of each LUN of drive array 120 and/or storage drawer 130.

In a further example embodiment, tier assignment program 200 can determine that endurance factor data 116 does not include historical information associated with a drive of drive array 120. In this example embodiment, tier assignment program 200can identify the drive as a new drive and then perform a check on an amount of P/E cycles performed on the drive. For example, tier assignment program 200 can communicate with a drive controller of the new drive to determine historical usage and endurance factor information associated with the drive. In addition, tier assignment program 200 can determine that a drive is no longer included in drive array (e.g., the drive has been replaced and/or failed) and that a new drive is a replacement for the removed and/or failed drive.

In step 206, tier assignment program 200 assigns each storage device to a respective endurance tier based on the determined endurance factor. In one embodiment, tier assignment program 200 assigns each storage device of the plurality of storage devices included in the customized LUN (created in step 202) to the corresponding endurance tier. In an example embodiment, tier assignment program 200 (in step 204) determines respective endurance factor values for drive 132A, drive 132B, drive 132C, and drive 132D, i.e., the storage devices in the customized LUN. In this example embodiment, drive 132A has a corresponding endurance factor value of 78%, drive 132B has a corresponding endurance factor value of 44%, drive 132C has a corresponding endurance factor value of 89%, and drive 132A has a corresponding endurance factor value of 97%. Tier assignment program 200 utilizes the determined respective endurance factor values to assign each storage device to the corresponding endurance tier, which can be defined as a range of endurance factor values.

As discussed previously in an example with regard to controller 115 and endurance factor data 116, controller 115 defines the endurance tiers based on a percentage of calculated remaining endurance for a respective drive (based on data in endurance factor data 116). In this example scenario, Tier A is reserved for drives with greater than or equal to 80% endurance, Tier B is reserved for drives with between 50% and 80% endurance, and Tier C is reserved for drives with less than or equal to 50% endurance. Accordingly, in this example scenario tier assignment program 200 assigns drive 132C and drive 132D to endurance Tier A, drive 132A to endurance tier B, and drive 132B to endurance Tier C.

In step 208, tier assignment program 200 saves data. In one embodiment, tier assignment program 200 saves the determined endurance factors (from step 204) and the assigned endurance tier (from step 206), associated with the respective storage devices of the created LUN (from step 202) in endurance factor data 116. In additional embodiments, allocates data among the drives of the LUN based on the respective assigned endurance tiers. For example, tier assignment program 200 can allocate read/write intensive data for storage in drive 132C and drive 132D, based on the assignment to endurance tier A.

Embodiments of the present invention utilize the assignment of endurance tiers and corresponding allocation of data to ensure that heterogeneous drives with different life cycles remaining can be grouped together in a storage array. For example, a 3-year old drive dated for five drive writes per day (DWPD) can be places together with a new read-intensive drive (e.g., 1 DWPD), facilitating use of components of different age and use within the storage architecture, in accordance with embodiments of the present invention.

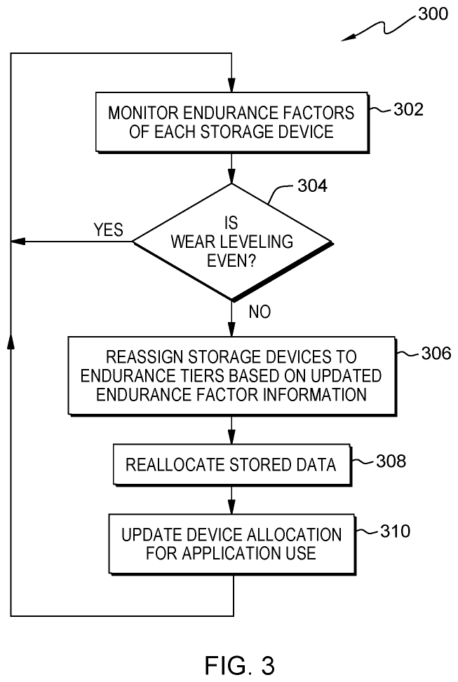

FIG. 3 is a flowchart depicting operational steps of wear leveling program 300, a program for dynamically managing a drive array based on drive endurance information, in accordance with an embodiment of the present invention. In one embodiment, wear leveling program 300 operates while computing system 110 and drive array 120 are active. In various embodiments of the present invention, wear leveling program 300 utilizes data stored in endurance factor data 116, which includes information generated through tier assignment program 300.

In step 302, wear leveling program 300 monitors endurance factors of each storage device. In one embodiment, wear leveling program 300 tracks counts of usage of storage devices in drive array 130 (e.g., P/E cycles), storing data in endurance factor data 116. For example, as an external application utilizes storage space in drive array 120 for read/write operations, wear leveling program 300 monitors the impact of the usage on endurance of storage devices and updates associated information in endurance factor data 116. In another embodiment, wear leveling program 300 monitors the storage devices in drive array 120, e.g., storage drawer 130. In an additional embodiment, respective instances of wear leveling program 300 operate concurrently to monitor respective LUNs of storage devices in drive array 120 (e.g., an instance of wear leveling program 300 monitors a LUN including drive 132A, drive 132B, drive 132C, and drive 132D, etc.).

In various embodiments of the present invention, wear leveling program 300 monitors real-time workload behavior of applications utilizing storage space on drive array 120. In example embodiments, wear leveling program 300 receives storage device usage information from respective drive controllers of storage devices in drive array 120. In an example scenario, wear leveling program 300 monitors usage of a LUN that includes drive 132A, drive 132B, drive 132C, and drive 132D (created in step 202 of tier management program 200). In this example, wear leveling program 300 receives drive usage information/parameters from respective drive controllers (e.g., a firmware component) of drive 132A, drive 132B, drive 132C, and drive 132D. Wear leveling program 300 can update endurance factor data accordingly. For example, a drive controller of drive 132C sends drive usage information that includes real-time P/E cycle data for drive 132C. In this example, wear leveling program 300 updates P/E cycle endurance information in endurance factor data 116 with the received drive usage information from the drive controller.

In step 304, wear leveling program 300 determines whether wear leveling across storage devices is even. In one embodiment, wear leveling program 300 determines whether drives in a group (e.g., a LUN) are wearing within a defined threshold or wear expectation (e.g., over time). In an example embodiment, endurance factor data 116 includes expected wear information and specified wear leveling parameters (e.g., an administrator defined amount of wear over time) for storage devices, such as SSDs. In another embodiment, wear leveling program 300 analyzes real-time drive wear data to monitor a wear rate of drives in drive array 120.

In example scenarios, wear leveling program 300 monitors the wear rate of drives to determine whether the wear rate of one or more drives is too fast/high, or remains within an expected specification. In additional examples, wear leveling program 300 determines whether a group of drives (e.g., drives in a LUN) are wearing similarly (e.g., a threshold percentage) relative to each respective drive in the group. For example, wear leveling program 300 monitors the LUN of drive 132A, drive 132B, drive 132C, and drive 132D to determine whether each drive has a wear rate within 5% of each other. In response to determining that wear leveling across storage devices is even (e.g., wear rate falls within specifications) (decision step 304, YES branch), wear leveling program 300 continues to monitor endurance factors of each storage device (return to step 304).

In another example embodiment, wear leveling program 300 monitors endurance factor information of drives relative to endurance tiers. For example, wear leveling program 300 monitors data received from a drive controller of drive 132C to determine a real-time endurance factor value for drive 132C. In this example, wear leveling program 300 tracks the real-time endurance factor value to determine if, based on real-time usage information, the endurance factor value of drive 132C drops from Tier B to Tier C (e.g., endurance factor value drops below 50%). Accordingly, in response to determining that an endurance factor value of a drive changes endurance tiers, wear leveling program 300 determines that wear leveling across storage devices is not even (decision step 304, NO branch).

In various embodiments of the present invention, wear leveling program 300 monitors wear leveling across devices to facilitate dynamic management of data allocation and application usage for storage in a heterogeneous array of SSDs. Responsive to determining that wear leveling across storage devices is not even (decision step 304, NO branch), wear leveling program 300 initiates the wear leveling process, in accordance with embodiments of the present invention.

In step 306, wear leveling program 300 reassigns storage devices to endurance tiers based on updated endurance factor information. More specifically, in response to determining that wear leveling across storage devices is not even (decision step 304, NO branch), wear leveling program 300 reassigns storage devices in drive array 120 to corresponding endurance tiers, based on updated information in endurance factor data 116. In various embodiments of the present invention, wear leveling program 300 can utilize techniques and processes previously discussed in detail with regard to step 204 and step 206 of tier assignment program 200 (FIG. 2). Wear leveling program 300 utilizes updated endurance factor information (stored in endurance factor data 116), derived through monitoring real-time endurance factor data for each storage device (in step 302).

In one embodiment, wear leveling program 300 dynamically reassigns each storage device that is included in a LUN (e.g., the customized LUN of step 202 of tier management program 200) to a corresponding endurance tier, based on the updated information. In another embodiment, wear leveling program 300 dynamically reassigns storage devices across multiple LUNs in drive array 120 (i.e., also dynamically reassigning LUNs), in accordance with embodiments of the present invention.

In an example embodiment, wear leveling program 300 determines updated respective endurance factor values for drive 132A, drive 132B, drive 132C, and drive 132D, i.e., the storage devices in a customized LUN. In this example embodiment, drive 132A has a corresponding endurance factor value of 72%, drive 132B has a corresponding endurance factor value of 40%, drive 132C has a corresponding endurance factor value of 78%, and drive 132A has a corresponding endurance factor value of 94%. Wear leveling program 300 utilizes the determined respective updated endurance factor values to reassign each storage device to the corresponding updated endurance tier (if applicable), which can be defined as a range of endurance factor values.

As discussed previously in an example with regard to controller 115 and endurance factor data 116, controller 115 defines the endurance tiers based on a percentage of calculated remaining endurance for a respective drive (based on data in endurance factor data 116). In this example scenario, Tier A is reserved for drives with greater than or equal to 80% endurance, Tier B is reserved for drives with between 50% and 80% endurance, and Tier C is reserved for drives with less than or equal to 50% endurance. Accordingly, in this example scenario wear leveling program 300 assigns drive 132D to endurance Tier A, drive 132A and drive 132C to endurance tier B, and drive 132B to endurance Tier C (i.e., reassigning drive 132C). In additional example embodiments, wear leveling program 300 can include additional drives in drive array 120 into the LUN of drive 132A through drive 132D, based on endurance factor information and external application requirements, in accordance with embodiments of the present invention.

In step 308, wear leveling program 300 reallocates stored data. In one embodiment, migrates data between storage devices based on the endurance tier reassignment (of step 306). In various embodiments of the present invention, drive array 120 employs data striping in storage devices. For example, data for an external application is stored across drives 132A through 132D (i.e., drives corresponding to a LUN). In the process of reallocating stored data (in response to reassigning drives to endurance tiers in step 306), wear leveling program 300 reallocates the stripes.

In an example scenario, wear leveling program 300 creates new data stripes and pools the stripes based on respective endurance tiers of drives, e.g., stripes for drives in a high endurance tier (e.g., Tier A) are grouped together. In additional example embodiments, wear leveling program 300 can distribute data writes across stripes belonging to the highest endurance tier (e.g., drive 132D in Tier A). In further embodiments, wear leveling program 300 associated a “hotness” factor with data written and wear leveling program 300 can migrate “cold” data to lower endurance tier devices (e.g., as a background process). For example, in response to determining that drive 132D is nearing capacity (based on write frequency), wear leveling program 300 can migrate cold data from drive 132D to drives in lower endurance tiers (i.e., drive 132A, drive 132B, and/or drive 132C).

In step 310, wear leveling program 300 updates device allocation for application use. In one embodiment, updates the allocation of storage devices to external applications, based on the reallocation of stored data (in step 308). In some embodiments, wear leveling program 300 proceeds to monitor endurance factors of each storage device (step 302), if the stored data reallocation (of step 308) does not change the allocation of storage devices to application and/or LUN. In various embodiments, in response to moving data across storage devices in drive array 120, wear leveling program 300 can dynamically update the associations of storage devices in drive array 120 to utilized applications.

In additional embodiments, wear leveling program 300 loops back to step 302 to continuously monitor endurance factors of each storage device. In further embodiments, wear leveling program 300 is actively operating while a storage system, such as drive array 120, is in use. In alternate embodiments, in response to a shot down of drive array 120, wear leveling program 300 terminates.

FIG. 4 depicts computer system 400, which is representative of computing system 110 and drive array 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to computing system 110, software and data 410 includes controller 115, endurance factor data 116, tier management program 200, and wear leveling program 300.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

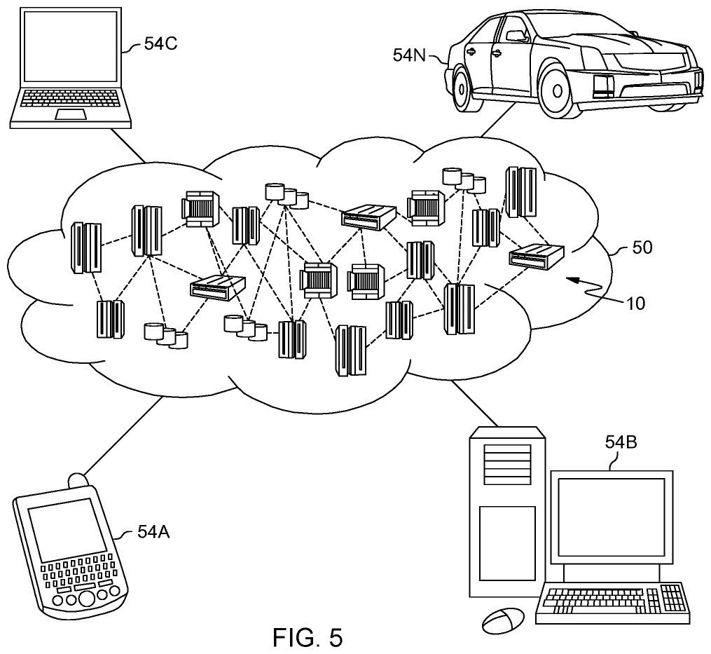

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

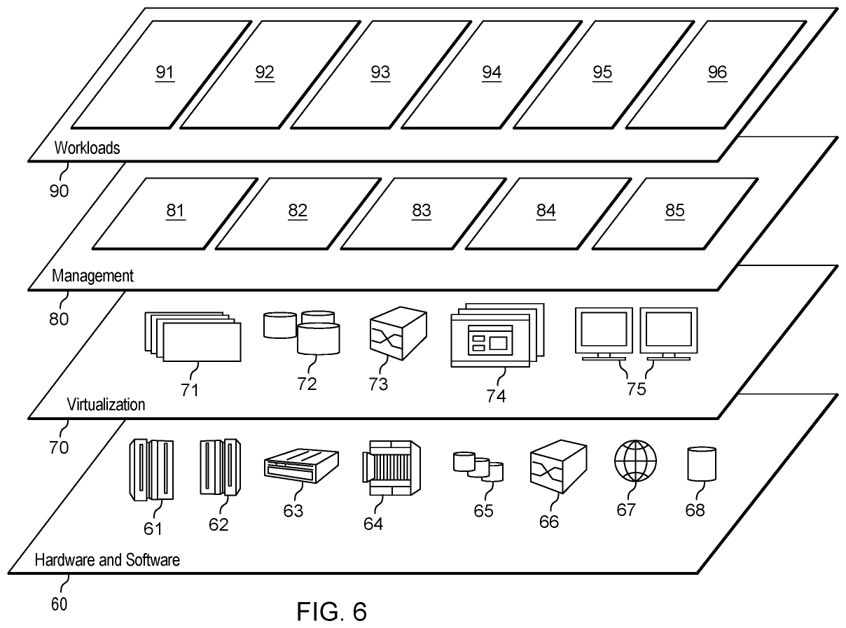

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software 96. In various embodiments of the present invention, software 96 is representative of controller 115, tier assignment program 200, and wear leveling program 300, or corresponding processing capabilities, described in further detail respectively with regard to FIG. 2 and FIG. 3.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a set of storage devices in a storage system, wherein each storage device of the set of storage devices is assigned to a corresponding endurance tier based on historical utilization of respective storage devices, wherein the endurance tiers correspond to a range of device endurance remaining for a storage device;
monitoring, by one or more processors, real-time endurance factor information for the set of storage devices; and
in response to determining that the monitored real-time endurance factor information indicates that the set of storage devices are not wearing evenly, reassigning, by one or more processors, at least one storage device of the set of storage devices to an updated endurance tier, corresponding to utilization of the at least one storage device.

2. The method of claim 1, further comprising:
collecting, by one or more processors, usage information for the set of storage devices on respective device controllers of each storage device of the set of storage devices.

3. The method of claim 1, further comprising:
reallocating, by one or more processors, data stored in the set of storage devices based on the reassignment of the at least one storage device of the set of storage devices to the updated endurance tier.

4. The method of claim 1, further comprising:
determining, by one or more processors, whether the respective storage devices of the set of storage devices are wearing within a defined threshold percentage of each other, based on the monitored real-time endurance factor information for the set of storage devices.

5. The method of claim 1, wherein the set of storage devices are a plurality of solid-state drives (SSDs) that correspond to a common logical unit number (LUN) in a drive array.

6. The method of claim 1, wherein the set of storage devices are a heterogeneous array of SSDs within a drive array.

7. The method of claim 1, wherein the real-time endurance factor information includes program/erase (P/E) cycles and indications of retired and reserve blocks for the storage devices of the set of storage devices.

8. A computer program product comprising:
one or more computer readable storage media and program instructions stored on the one or more computer readable storage media, the program instructions comprising:
program instructions to identify a set of storage devices in a storage system, wherein each storage device of the set of storage devices is assigned to a corresponding endurance tier based on historical utilization of respective storage devices, wherein the endurance tiers correspond to a range of device endurance remaining for a storage device;
program instructions to monitor real-time endurance factor information for the set of storage devices; and
in response to determining that the monitored real-time endurance factor information indicates that the set of storage devices are not wearing evenly, program instructions to reassign at least one storage device of the set of storage devices to an updated endurance tier, corresponding to utilization of the at least one storage device.

9. The computer program product of claim 8, further comprising program instructions, stored on the one or more computer readable storage media, to:
collect usage information for the set of storage devices on respective device controllers of each storage device of the set of storage devices.

10. The computer program product of claim 8, further comprising program instructions, stored on the one or more computer readable storage media, to:
reallocate data stored in the set of storage devices based on the reassignment of the at least one storage device of the set of storage devices to the updated endurance tier.

11. The computer program product of claim 8, further comprising program instructions, stored on the one or more computer readable storage media, to:
determine whether the respective storage devices of the set of storage devices are wearing within a defined threshold percentage of each other, based on the monitored real-time endurance factor information for the set of storage devices.

12. The computer program product of claim 8, wherein the set of storage devices are a plurality of solid-state drives (SSDs) that correspond to a common logical unit number (LUN) in a drive array.

13. The computer program product of claim 8, wherein the real-time endurance factor information includes program/erase (P/E) cycles and indications of retired and reserve blocks for the storage devices of the set of storage devices.

14. A computer system comprising:
one or more computer processors;
one or more computer readable storage media; and
program instructions stored on the computer readable storage media for execution by at least one of the one or more processors, the program instructions comprising:
program instructions to identify a set of storage devices in a storage system, wherein each storage device of the set of storage devices is assigned to a corresponding endurance tier based on historical utilization of respective storage devices, wherein the endurance tiers correspond to a range of device endurance remaining for a storage device;
program instructions to monitor real-time endurance factor information for the set of storage devices; and
in response to determining that the monitored real-time endurance factor information indicates that the set of storage devices are not wearing evenly, program instructions to reassign at least one storage device of the set of storage devices to an updated endurance tier, corresponding to utilization of the at least one storage device.

15. The computer system of claim 14, further comprising program instructions, stored on the computer readable storage media for execution by at least one of the one or more processors, to:
collect usage information for the set of storage devices on respective device controllers of each storage device of the set of storage devices.

16. The computer system of claim 14, further comprising program instructions, stored on the computer readable storage media for execution by at least one of the one or more processors, to:
reallocate data stored in the set of storage devices based on the reassignment of the at least one storage device of the set of storage devices to the updated endurance tier.

17. The computer system of claim 14, further comprising program instructions, stored on the computer readable storage media for execution by at least one of the one or more processors, to:
determine whether the respective storage devices of the set of storage devices are wearing within a defined threshold percentage of each other, based on the monitored real-time endurance factor information for the set of storage devices.

18. The computer system of claim 14, wherein the set of storage devices are a plurality of solid-state drives (SSDs) that correspond to a common logical unit number (LUN) in a drive array.

19. The computer system of claim 14, wherein the set of storage devices are a heterogeneous array of SSDs within a drive array.

20. The computer system of claim 14, wherein the real-time endurance factor information includes program/erase (P/E) cycles and indications of retired and reserve blocks for the storage devices of the set of storage devices.
